(19) United States
(12) Patent Application Publication
(10) Pub. No.: US 2022/0270382 A1
(43) Pub. Date: Aug. 25, 2022

(54) METHOD AND APPARATUS OF TRAINING IMAGE RECOGNITION MODEL, METHOD AND APPARATUS OF RECOGNIZING IMAGE, AND ELECTRONIC DEVICE

(71) Applicant: Beijing Baidu Netcom Science Technology Co., Ltd., Beijing (CN)

(72) Inventor: Xiaoming MA, Beijing (CN)

(21) Appl. No.: 17/741,780

(22) Filed: May 11, 2022

(30) Foreign Application Priority Data
Jun. 25, 2021 (CN) 202110714944.5

(51) Int. Cl. G06V 20/62; G06V 10/77; G06V 10/80; G06V 10/82

(52) U.S. Cl. CPC G06V 20/63; G06V 10/7715; G06V 10/80; G06V 10/82

(57) ABSTRACT

The present application provides a method and an apparatus of training an image recognition model, a method and an apparatus of recognizing an image, and an electronic device, which relates to a field of an image processing technology, and in particular to artificial intelligence and computer vision technology. A specific implementation scheme of the present disclosure includes: determining a training sample set including a plurality of sample pictures and a text label for each sample picture; extracting an image feature of each sample picture and a semantic feature of each sample picture based on a feature extraction network of a basic image recognition model; and training the basic image recognition model based on the extracted image feature of each sample picture, the extracted semantic feature of each sample picture, the text label for each sample picture, a predetermined image classification loss function, and a predetermined semantic classification loss function.

### CROSS-REFERENCE TO RELATED APPLICATION(S)

This application claims the priority of Chinese Patent Application No. 202110714944.5, filed on Jun. 25, 2021, the entire contents of which are hereby incorporated by reference.

### TECHNICAL FIELD

The present disclosure relates to a field of an image processing technology, in particular to a technical field of artificial intelligence and computer vision technology.

### BACKGROUND

A signboard text recognition technology is mainly implemented to detect a text area from a merchant signboard and recognize decodable Chinese and English text in the text area. A result of recognition is of great significance to a new production of POI and an automatic association with signboard. Since the signboard text recognition technology is an important part of an entire production, how to accurately recognize the text in the signboard has become a problem.

### SUMMARY

The present disclosure provides a method and an apparatus of training an image recognition model, a method and an apparatus of recognizing an image, and an electronic device.

According to a first aspect of the present disclosure, there is provided a method of training an image recognition model, including:

determining a training sample set including a plurality of sample pictures and a text label for each sample picture; wherein at least part of the plurality of sample pictures in the training sample set contains an irregular text, an occluded text or a blurred text;

extracting an image feature of each sample picture and a semantic feature of each sample picture based on a feature extraction network of a basic image recognition model; and

training the basic image recognition model based on the extracted image feature of each sample picture, the extracted semantic feature of each sample picture, the text label for each sample picture, a predetermined image classification loss function, and a predetermined semantic classification loss function.

According to a second aspect of the present disclosure, there is provided a method of recognizing an image, including:

acquiring a to-be-recognized target picture; and

inputting the to-be-recognized target picture into an image recognition model trained in the first aspect, so as to obtain a text information for the to-be-recognized target picture.

According to a third aspect of the present disclosure, there is provided an electronic device, including:

at least one processor; and

a memory communicatively connected to the at least one processor, wherein the memory stores instructions executable by the at least one processor, and the instructions, when executed by the at least one processor, cause the at least one processor to implement the method described above.

According to a fourth aspect of the present disclosure, there is provided a non-transitory computer-readable storage medium having computer instructions stored thereon, wherein the computer instructions allow a computer to implement the method described above.

It should be understood that content described in this section is not intended to identify key or important features in the embodiments of the present disclosure, nor is it intended to limit the scope of the present disclosure. Other features of the present disclosure will be easily understood through the following description.

### BRIEF DESCRIPTION OF THE DRAWINGS

The accompanying drawings are used to understand the solution better and do not constitute a limitation to the present disclosure.

FIG. 1 shows a flowchart of a method of training an image recognition model provided according to the present disclosure.

FIG. 2 shows an example diagram of a method of training an image recognition model provided according to the present disclosure.

FIG. 3 shows a flowchart of a method of recognizing an image provided according to the present disclosure.

FIG. 4 shows an example diagram of a method of recognizing an image provided according to the present disclosure.

FIG. 5 shows a schematic structural diagram of an apparatus of training an image recognition model provided by the present disclosure.

FIG. 6 shows a schematic structural diagram of an apparatus of recognizing an image provided by the present disclosure.

FIG. 7 shows a block diagram of an electronic device for implementing the embodiments of the present disclosure.

### DETAILED DESCRIPTION OF EMBODIMENTS

Exemplary embodiments of the present disclosure are described below with reference to the accompanying drawings, which include various details of the embodiments of the present disclosure to facilitate understanding, and should be considered as merely exemplary. Therefore, those of ordinary skilled in the art should realize that various changes and modifications may be made to the embodiments described herein without departing from the scope and spirit of the present disclosure. Likewise, for clarity and conciseness, descriptions of well-known functions and structures are omitted in the following description.

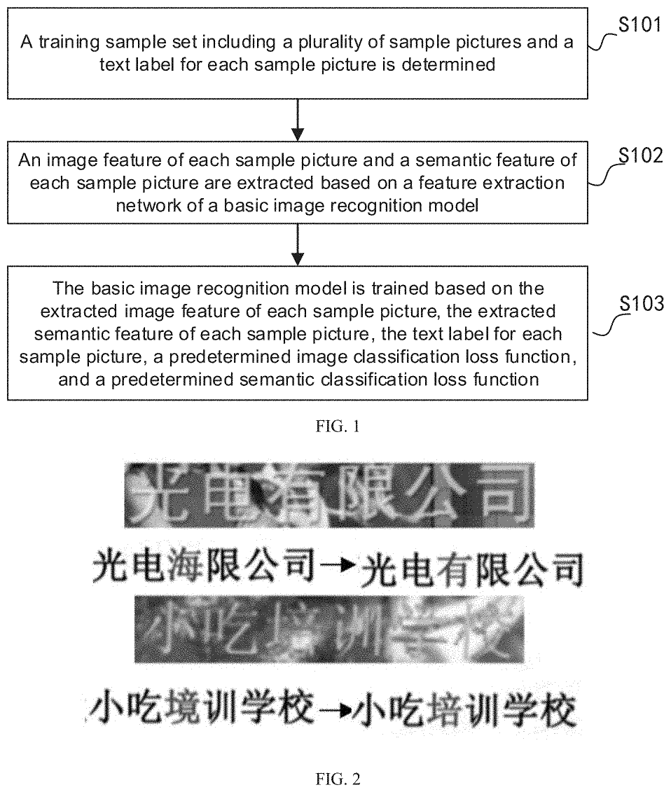

FIG. 1 shows a method of training an image recognition model provided by the embodiment of the present disclosure. As shown in FIG. 1, the method includes step S101 to step S103.

In step S101, a training sample set including a plurality of sample pictures and a text label for each sample picture is determined. At least part of the plurality of sample pictures in the training sample set contains an irregular text, an occluded text or a blurred text.

Specifically, the sample set may be determined by manual labeling, or the sample set may be obtained by processing unlabeled sample data in an unsupervised or weakly supervised manner. The training sample set may include a positive sample and a negative sample. The text label may be a desired text to be obtained by performing an image recognition on the sample picture. At least part of the plurality of sample pictures in the training sample set may contain an irregular text, an occluded text or a blurred text, or contain an occluded and blurred text. Exemplarily, the picture sample shown in FIG. 2 has a problem of occlusion or blur.

In step S102, an image feature of each sample picture and a semantic feature of each sample picture are extracted based on a feature extraction network of a basic image recognition model.

Specifically, the image feature of the sample picture may be extracted through a convolution neural network, for example, through a deep network structure such as VGG Net, ResNet, ResNeXt, SE-Net, etc. that contains a multi-layer convolutional neural network. Specifically, the image feature of the sample picture may be extracted using Resnet-50, so that both accuracy and speed of a feature extraction may be taken into account.

Specifically, the semantic feature of the sample picture may be extracted through a Transformer-based network.

The image feature of the sample picture and the semantic feature of the sample picture may also be extracted by other methods with which the present disclosure may be implemented, such as long-term and short-term neural networks.

In step S103, the basic image recognition model is trained based on the extracted image feature of each sample picture, the extracted semantic feature of each sample picture, the text label for each sample picture, a predetermined image classification loss function, and a predetermined semantic classification loss function.

Specifically, an image classification loss value and a semantic classification loss value may be determined based on the image feature of each sample picture, the semantic feature of each sample picture, the text label for each sample picture, the predetermined image classification loss function and the predetermined semantic classification loss function, then a model parameter of the basic image recognition model may be adjusted based on the determined loss value until a convergence, so as to obtain the trained image recognition model.

Compared with a related art of image recognition in which only an image semantic information is taken into account and a text semantic information is not taken into account, the present disclosure may be implemented to determine a training sample set including a plurality of sample pictures and a text label for each sample picture; then extract an image feature of each sample picture and a semantic feature of each sample picture based on a feature extraction network of a basic image recognition model; and then train the basic image recognition model based on the extracted image feature of each sample picture, the extracted semantic feature of each sample picture, the text label for each sample picture, a predetermined image classification loss function, and a predetermined semantic classification loss function. In other words, when training the image recognition model, a visual perception information and a text semantic information are both taken into account, so that even the irregular text, the blurred text or the occluded text in the image may be correctly recognized.

The embodiment of the present disclosure provides a possible implementation, in which the sample picture includes at least one of a shop sign picture, a billboard picture and a slogan picture.

A POI (point of interest) production link may be divided into several links including a signboard extraction, an automatic processing, a coordinate production and a manual operation, which ultimately aims to produce POI name and POI coordinates in a real world through an entire production.

A signboard text recognition technology (which may also be a billboard picture recognition or a slogan picture recognition) is mainly implemented to detect a text area from a merchant signboard and recognize decodable Chinese and English format for the text area. A result of recognition is of great significance to a new production of POI and an automatic association with the signboard. Since the signboard text recognition technology is an important part of the entire production, it is necessary to improve an accuracy of recognizing an effective POI text.

At present, a main difficulty in a merchant signboard text recognition focuses on a problem of occlusion and blur. How to recognize a text in an occluded text area or a blurred text area of the signboard in a model training process has become a problem. A common natural scene text recognition is only implemented to classify according to an image feature. However, POI is a text segment with a semantic information. The technical solution of the present disclosure may assist in the text recognition by extracting a text image feature of a shop sign picture, a billboard picture, a slogan picture, etc. and a text semantic feature thereof. Specifically, a visual attention mechanism may be used to extract the text image feature in the shop sign picture, the billboard picture and the slogan picture, and at the same time, an encoding and decoding method of Transformer may be used to mine an inherent semantic information of POI to assist in the text recognition, so as to effectively improve a robustness of the recognition of an irregular POI text, an occluded POI text and a blurred POI text.

The embodiment of the present disclosure provides a possible implementation, in which the training the basic image recognition model based on the extracted image feature of each sample picture, the extracted semantic feature of each sample picture, the text label for each sample picture, a predetermined image classification loss function, and a predetermined semantic classification loss function includes: training the basic image recognition model based on the extracted image feature of each sample picture, the extracted semantic feature of each sample picture, the text label for each sample picture, the predetermined image classification loss function, the predetermined semantic classification loss function, and a predetermined ArcFace loss function for aggregating feature information of the same class of target objects and dispersing feature information of different classes of target objects.

Specifically, the ArcFace loss function may be introduced into a process of training a classification model so as to determine a loss value of the classification model. Through the ArcFace loss function, a distance between the same class of target objects may be decreased, and a distance between different classes of target objects, for example, a distance between similar words “ [symbol] ” and “ [symbol] ”, may be increased, so as to improve an ability of classifying easily confused target objects. In the embodiments of the present disclosure, a description of the ArcFace loss function may refer to the existing ArcFace loss function, which is not specifically limited here.

The embodiment of the present disclosure provides a possible implementation, in which the method may further include: performing a fusion based on the image feature of the sample picture and the semantic feature of the sample picture, so as to determine a fusion sample feature; and determine a fusion loss based on the fusion sample feature and the ArcFace loss function.

Specifically, a fusion, such as a linear fusion, a direct stitching, etc., may be performed based on the image feature of the sample picture and the semantic feature of the sample picture, so as to determine the fusion sample feature. Then, a fusion loss may be determined based on the fusion sample feature and the ArcFace loss function, so as to cooperate with the image classification loss and the semantic classification loss. A fitting may be performed on the network through a multi-channel loss calculation, so that an accuracy of the trained image recognition model may be further improved.

The embodiment of the present disclosure provides a possible implementation, in which the method may further include: determining a weight value for the image classification loss function, a weight value for the semantic classification loss function and a weight value for the ArcFace loss function; and training the basic image recognition model based on the predetermined image classification loss function, the predetermined semantic classification loss function, the predetermined ArcFace loss function, the determined weight value for the image classification loss function, the determined weight value for the semantic classification loss function and the determined weight value for the ArcFace loss function.

Specifically, the image classification loss function, the semantic classification loss function and the ArcFace loss function may correspond to respective weight values, so that an importance of the image feature, an importance of the text semantic feature and an importance of the fusion feature in the model training may be measured. Specifically, the weight may be an empirical value or may be obtained through training.

The embodiment of the present disclosure provides a possible implementation, in which the sample picture includes a plurality of text areas, and each text area contains at least one character, and the method may further include: extracting a feature vector of a target text area from the plurality of text areas based on an attention network; and extracting the image feature of the sample picture and the semantic feature of the sample picture based on the extracted feature vector of the target text area.

Specifically, an attention network may be introduced so that the recognition may be performed on an image area containing useful information, rather than all text areas in the image, so as to avoid introducing a noise information into a recognition result.

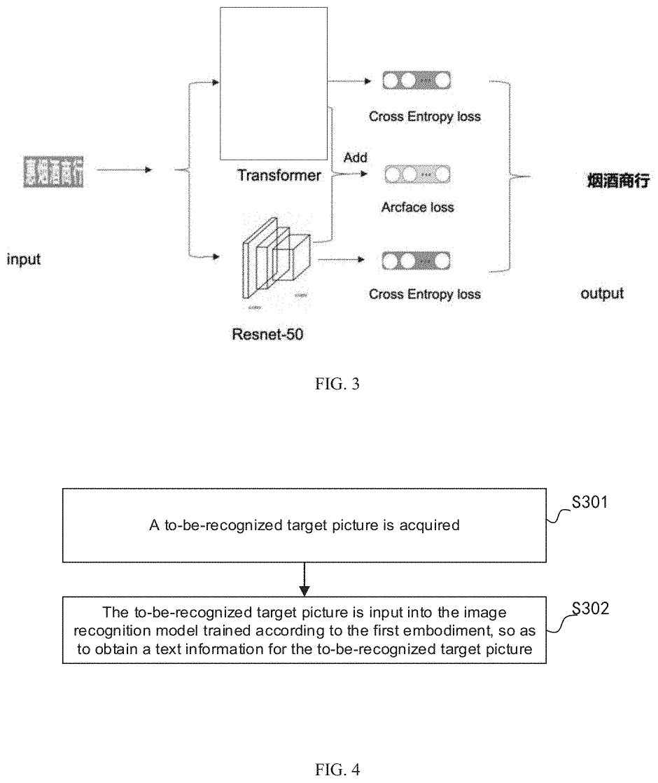

Exemplarily, as shown in FIG. 3, when training the image recognition model, the image feature of the sample image is extracted through Resnet-50 of the basic image recognition model, and the semantic feature of the sample image is extracted through Transformer, and then the model is trained based on three determined loss functions including the image classification loss function, the semantic classification loss function and the ArcFace loss function. The image classification loss function and the semantic classification loss function may be a cross entropy loss function or other loss functions with which the functions of the present disclosure may be achieved.

According to a second aspect of the present disclosure, there is provided a method of recognizing an image. As shown in FIG. 4, the method includes step S401 and step S402.

In step S401, a to-be-recognized target picture is acquired.

Specifically, the to-be-recognized target picture may be a directly captured picture or a picture extracted from a captured video. The to-be-recognized target picture may contain an irregular text, an occluded text or a blurred text.

In step S402, the to-be-recognized target picture is input into the image recognition model trained according to the first embodiment, so as to obtain a text information for the to-be-recognized target picture.

Specifically, when the to-be-recognized target picture is input into the image recognition model trained according to the first embodiment, a corresponding detection and recognition processing may be performed to obtain the text information for the to-be-recognized target picture.

In order to better understand the technical solution of the present disclosure, exemplarily, as shown in FIG. 2, when the image in FIG. 2 is recognized according to the technical solution of the present disclosure, the recognition results of “ [symbol] ” and “ [symbol] ” may be obtained respectively, while in the related art, the recognition processing may only be performed according to the image feature to obtain wrong recognition results of “ [symbol] ” and “ [symbol] ” when the to-be-recognized image is occluded or blurred, in which “ [symbol] ” is mistakenly recognized as “ [symbol] ”, and “ [symbol] ” is mistakenly recognized as “ [symbol] ”, so that the image may not be recognized correctly.

Compared with the related art of image recognition in which only the image semantic information is taken into account and the text semantic information is not taken into account, the present disclosure may be implemented to obtain the corresponding text information by acquiring the to-be-recognized image and recognizing the to-be-recognized image based on the image recognition model trained according to the first embodiment. In other words, the image is recognized using the image recognition model in which the visual perception information and the text semantic information are both taken into account, so that even the irregular text, the blurred text or the occluded text in the image may be correctly recognized.

The embodiment of the present disclosure provides a possible implementation, in which the sample picture includes at least one of a shop sign picture, a billboard picture and a slogan picture.

For the embodiment of the present disclosure, when recognizing a signboard image (the shop sign picture, the billboard picture and the slogan picture), the visual perception information and the text semantic information are taken into account, so that the accuracy of recognition may be improved.

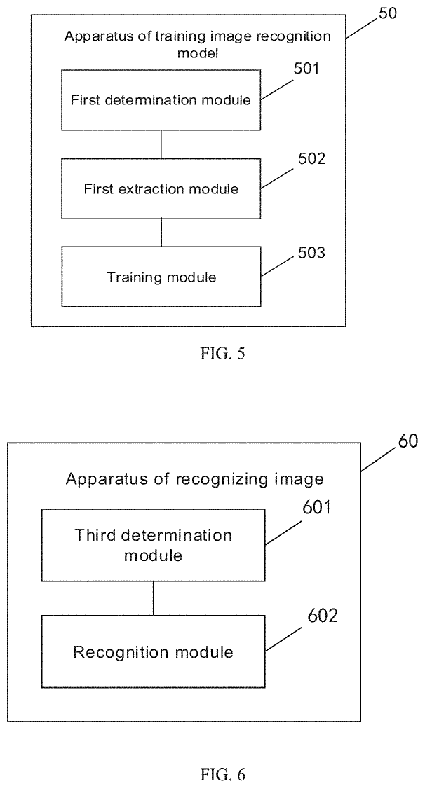

The embodiment of the present disclosure provides an apparatus 50 of training an image recognition model. As shown in FIG. 5, the apparatus 50 includes a first determination module 501, a first extraction module 502, and a training module 503.

The first determination module 501 is used to determine a training sample set including a plurality of sample pictures and a text label for each sample picture. At least part of the plurality of sample pictures in the training sample set may contain an irregular text, an occluded text or a blurred text.

The first extraction module 502 is used to extract an image feature of each sample picture and a semantic feature of each sample picture based on a feature extraction network of a basic image recognition model.

The training module 503 is used to train the basic image recognition model based on the extracted image feature of each sample picture, the extracted semantic feature of each sample picture, a text label for each sample picture, a predetermined image classification loss function, and a predetermined semantic classification loss function.

The embodiment of the present disclosure provides a possible implementation, in which the sample picture includes at least one of a shop sign picture, a billboard picture and a slogan picture.

The embodiment of the present disclosure provides a possible implementation, in which the training module 503 is specifically used to train the basic image recognition model based on the extracted image feature of each sample picture, the extracted semantic feature of each sample picture, the text label for each sample picture, the predetermined image classification loss function, the predetermined semantic classification loss function, and a predetermined ArcFace loss function for aggregating feature information of the same class of target objects and dispersing feature information of different classes of target objects.

The embodiment of the present disclosure provides a possible implementation, in which the apparatus 50 may further include: a second determination module 504 (not shown) used to perform a fusion based on the image feature of the sample picture and the semantic feature of the sample picture, so as to determine a fusion sample feature; and a construction module 505 (not shown) used to determine a fusion loss based on the fusion sample feature and the ArcFace loss function.

The embodiment of the present disclosure provides a possible implementation, in which the apparatus 50 may further include a third determination module 506 (not shown) used to determine a weight value for the image classification loss function, a weight value for the semantic classification loss function and a weight value for the ArcFace loss function; and the training module 503 (not shown) is specifically used to train the basic image recognition model based on the predetermined image classification loss function, the predetermined semantic classification loss function, the predetermined ArcFace loss function, the determined weight value for the image classification loss function, the determined weight value for the semantic classification loss function and the determined weight value for the ArcFace loss function.

The embodiment of the present disclosure provides a possible implementation, in which the sample picture includes a plurality of text areas, and each text area contains at least one character, and the apparatus may further include: a second extraction module 507 (not shown) used to extract a feature vector of a target text area from the plurality of text areas based on an attention network; and a first extraction module 508 (not shown) used to extract the image feature of the sample picture and the semantic feature of the sample picture based on the extracted feature vector of the target text area.

A beneficial effect achieved by the embodiment of the present disclosure is the same as that achieved by the above embodiment of method, which will not be repeated here.

The embodiment of the present disclosure provides an apparatus 60 of recognizing an image. As shown in FIG. 6, the apparatus 60 includes: a third determination module 601 used to determine a to-be-recognized target picture; and a recognition module 602 used to input the to-be-recognized target picture into the image recognition model trained according to the first embodiment, so as to obtain a text information for the to-be-recognized target picture.

Compared with the related art of image recognition in which only the image semantic information is taken into account and the text semantic information is not taken into account, the present disclosure may be implemented to obtain the corresponding text information by acquiring the to-be-recognized image and recognizing the to-be-recognized image based on the image recognition model trained according to the first embodiment. In other words, the image is recognized using the image recognition model in which the visual perception information and the text semantic information are both taken into account, so that even the irregular text, the blurred text or the occluded text in the image may be correctly recognized.

The embodiment of the present disclosure provides a possible implementation, in which the sample picture includes at least one of a shop sign picture, a billboard picture and a slogan picture.

A beneficial effect achieved by the embodiment of the present disclosure is the same as that achieved by the above embodiment of method, which will not be repeated here.

In the technical solution of the present disclosure, an acquisition, a storage and an application of various user personal information involved comply with provisions of relevant laws and regulations, and do not violate public order and good custom.

According to the embodiments of the present disclosure, the present disclosure further provides an electronic device, a readable storage medium, and a computer program product.

The electronic device may include: at least one processor; and a memory communicatively connected to the at least one processor, the memory stores instructions executable by the at least one processor, and the instructions, when executed by the at least one processor, cause the at least one processor to implement the method provided by the embodiments of the present disclosure.

Compared with the related art of image recognition in which only the image semantic information is taken into account and the text semantic information is not taken into account, the present disclosure may be implemented to determine a training sample set including a plurality of sample pictures and a text label for each sample picture; then extract an image feature of each sample picture and a semantic feature of each sample picture based on a feature extraction network of a basic image recognition model; and then train the basic image recognition model based on the extracted image feature of each sample picture, the extracted semantic feature of each sample picture, the text label for each sample picture, a predetermined image classification loss function, and a predetermined semantic classification loss function. In other words, when training the image recognition model, a visual perception information and a text semantic information are both taken into account, so that even the irregular text, the blurred text or the occluded text in the image may be correctly recognized.

The readable storage medium is a non-transitory computer-readable storage medium having computer instructions stored thereon, and the computer instructions may allow a computer to perform the method provided by the embodiments of the present disclosure.

Compared with the related art of image recognition in which only the image semantic information is taken into account and the text semantic information is not taken into account, the readable storage medium of present disclosure may be implemented to determine a training sample set including a plurality of sample pictures and a text label for each sample picture; then extract an image feature of each sample picture and a semantic feature of each sample picture based on a feature extraction network of a basic image recognition model; and then train the basic image recognition model based on the extracted image feature of each sample picture, the extracted semantic feature of each sample picture, the text label for each sample picture, a predetermined image classification loss function, and a predetermined semantic classification loss function. In other words, when training the image recognition model, a visual perception information and a text semantic information are both taken into account, so that even the irregular text, the blurred text or the occluded text in the image may be correctly recognized.

The computer program product may contain a computer program, and the computer program, when executed by a processor, is allowed to implement the method described in the first aspect of the present disclosure.

Compared with the related art of image recognition in which only the image semantic information is taken into account and the text semantic information is not taken into account, the computer program product of the present disclosure may be implemented to determine a training sample set including a plurality of sample pictures and a text label for each sample picture; then extract an image feature of each sample picture and a semantic feature of each sample picture based on a feature extraction network of a basic image recognition model; and then train the basic image recognition model based on the extracted image feature of each sample picture, the extracted semantic feature of each sample picture, the text label for each sample picture, a predetermined image classification loss function, and a predetermined semantic classification loss function. In other words, when training the image recognition model, a visual perception information and a text semantic information are both taken into account, so that even the irregular text, the blurred text or the occluded text in the image may be correctly recognized.

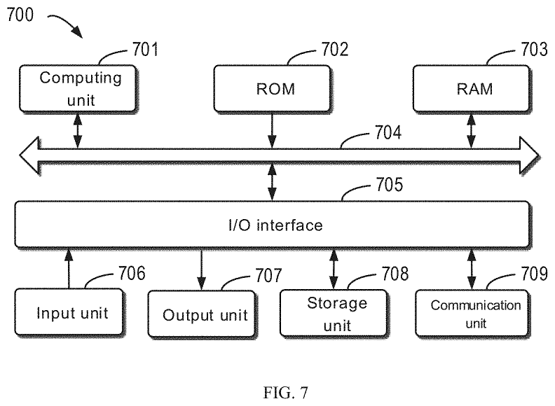

FIG. 7 shows a schematic block diagram of an exemplary electronic device 700 for implementing the embodiments of the present disclosure. The electronic device is intended to represent various forms of digital computers, such as a laptop computer, a desktop computer, a workstation, a personal digital assistant, a server, a blade server, a mainframe computer, and other suitable computers. The electronic device may further represent various forms of mobile devices, such as a personal digital assistant, a cellular phone, a smart phone, a wearable device, and other similar computing devices. The components as illustrated herein, and connections, relationships, and functions thereof are merely examples, and are not intended to limit the implementation of the present disclosure described and/or required herein.

As shown in FIG. 7, the electronic device 700 may include a computing unit 701, which may perform various appropriate actions and processing based on a computer program stored in a read-only memory (ROM) 702 or a computer program loaded from a storage unit 708 into a random access memory (RAM) 703. Various programs and data required for the operation of the electronic device 700 may be stored in the RAM 703. The computing unit 701, the ROM 702 and the RAM 703 are connected to each other through a bus 704. An input/output (I/O) interface 705 is further connected to the bus 704.

Various components in the electronic device 700, including an input unit 706 such as a keyboard, a mouse, etc., an output unit 707 such as various types of displays, speakers, etc., a storage unit 708 such as a magnetic disk, an optical disk, etc., and a communication unit 709 such as a network card, a modem, a wireless communication transceiver, etc., are connected to the I/O interface 705. The communication unit 709 allows the electronic device 700 to exchange information/data with other devices through a computer network such as the Internet and/or various telecommunication networks.

The computing unit 701 may be various general-purpose and/or special-purpose processing components with processing and computing capabilities. Some examples of the computing unit 701 include but are not limited to a central processing unit (CPU), a graphics processing unit (GPU), various dedicated artificial intelligence (AI) computing chips, various computing units running machine learning model algorithms, a digital signal processor (DSP), and any appropriate processor, controller, microcontroller, and so on. The computing unit 701 may perform the various methods and processes described above, such as the method of training the image recognition model and the method of recognizing the image. For example, in some embodiments, the method of training the image recognition model and the method of recognizing the image may be implemented as a computer software program that is tangibly contained on a machine-readable medium, such as the storage unit 708. In some embodiments, part or all of a computer program may be loaded and/or installed on the electronic device 700 via the ROM 702 and/or the communication unit 709. When the computer program is loaded into the RAM 703 and executed by the computing unit 701, one or more steps of the method of training the image recognition model and the method of recognizing the image described above may be performed. Alternatively, in other embodiments, the computing unit 701 may be configured to perform the method of training the image recognition model and the method of recognizing the image in any other appropriate way (for example, by means of firmware).

Various embodiments of the systems and technologies described herein may be implemented in a digital electronic circuit system, an integrated circuit system, a field programmable gate array (FPGA), an application specific integrated circuit (ASIC), an application specific standard product (ASSP), a system on chip (SOC), a complex programmable logic device (CPLD), a computer hardware, firmware, software, and/or combinations thereof. These various embodiments may be implemented by one or more computer programs executable and/or interpretable on a programmable system including at least one programmable processor. The programmable processor may be a dedicated or general-purpose programmable processor, which may receive data and instructions from the storage system, the at least one input device and the at least one output device, and may transmit the data and instructions to the storage system, the at least one input device, and the at least one output device.

Program codes for implementing the method of the present disclosure may be written in any combination of one or more programming languages. These program codes may be provided to a processor or a controller of a general-purpose computer, a special-purpose computer, or other programmable data processing devices, so that when the program codes are executed by the processor or the controller, the functions/operations specified in the flowchart and/or block diagram may be implemented. The program codes may be executed completely on the machine, partly on the machine, partly on the machine and partly on the remote machine as an independent software package, or completely on the remote machine or the server.

In the context of the present disclosure, the machine readable medium may be a tangible medium that may contain or store programs for use by or in combination with an instruction execution system, device or apparatus. The machine readable medium may be a machine-readable signal medium or a machine-readable storage medium. The machine readable medium may include, but not be limited to, electronic, magnetic, optical, electromagnetic, infrared or semiconductor systems, devices or apparatuses, or any suitable combination of the above. More specific examples of the machine readable storage medium may include electrical connections based on one or more wires, portable computer disks, hard disks, random access memory (RAM), read-only memory (ROM), erasable programmable read-only memory (EPROM or flash memory), optical fiber, convenient compact disk read-only memory (CD-ROM), optical storage device, magnetic storage device, or any suitable combination of the above.

In order to provide interaction with users, the systems and techniques described here may be implemented on a computer including a display device (for example, a CRT (cathode ray tube) or LCD (liquid crystal display) monitor) for displaying information to the user), and a keyboard and a pointing device (for example, a mouse or a trackball) through which the user may provide the input to the computer. Other types of devices may also be used to provide interaction with users. For example, a feedback provided to the user may be any form of sensory feedback (for example, visual feedback, auditory feedback, or tactile feedback), and the input from the user may be received in any form (including acoustic input, voice input or tactile input).

The systems and technologies described herein may be implemented in a computing system including back-end components (for example, a data server), or a computing system including middleware components (for example, an application server), or a computing system including front-end components (for example, a user computer having a graphical user interface or web browser through which the user may interact with the implementation of the system and technology described herein), or a computing system including any combination of such back-end components, middleware components or front-end components. The components of the system may be connected to each other by digital data communication (for example, a communication network) in any form or through any medium. Examples of the communication network include a local area network (LAN), a wide area network (WAN), and Internet.

The computer system may include a client and a server. The client and the server are generally far away from each other and usually interact through a communication network. The relationship between the client and the server is generated through computer programs running on the corresponding computers and having a client-server relationship with each other. The server may be a cloud server, a server of a distributed system, or a server combined with a blockchain.

It should be understood that steps of the processes illustrated above may be reordered, added or deleted in various manners. For example, the steps described in the present disclosure may be performed in parallel, sequentially, or in a different order, as long as a desired result of the technical solution of the present disclosure may be achieved. This is not limited in the present disclosure.

The above-mentioned specific embodiments do not constitute a limitation on the scope of protection of the present disclosure. Those skilled in the art should understand that various modifications, combinations, sub-combinations and substitutions may be made according to design requirements and other factors. Any modifications, equivalent replacements and improvements made within the spirit and principles of the present disclosure shall be contained in the scope of protection of the present disclosure.

What is claimed is:

1. A method of training an image recognition model, comprising:
determining a training sample set comprising a plurality of sample pictures and a text label for each sample picture; wherein at least part of the plurality of sample pictures in the training sample set contains an irregular text, an occluded text or a blurred text;
extracting an image feature of each sample picture and a semantic feature of each sample picture based on a feature extraction network of a basic image recognition model; and
training the basic image recognition model based on the extracted image feature of each sample picture, the extracted semantic feature of each sample picture, the text label for each sample picture, a predetermined image classification loss function, and a predetermined semantic classification loss function.

2. The method of claim 1, wherein the sample picture comprises at least one of a shop sign picture, a billboard picture and a slogan picture.

3. The method of claim 1, wherein the training the basic image recognition model based on the extracted image feature of each sample picture, the extracted semantic feature of each sample picture, the text label for each sample picture, a predetermined image classification loss function, and a predetermined semantic classification loss function comprises:
training the basic image recognition model based on the extracted image feature of each sample picture, the extracted semantic feature of each sample picture, the text label for each sample picture, the predetermined image classification loss function, the predetermined semantic classification loss function, and a predetermined ArcFace loss function for aggregating feature information of the same class of target objects and dispersing feature information of different classes of target objects.

4. The method of claim 3, further comprising:
performing a fusion based on the image feature of the sample picture and the semantic feature of the sample picture, so as to determine a fusion sample feature; and
determining a fusion loss based on the fusion sample feature and the ArcFace loss function.

5. The method of claim 3, further comprising:
determining a weight value for the image classification loss function, a weight value for the semantic classification loss function and a weight value for the ArcFace loss function; and
training the basic image recognition model based on the predetermined image classification loss function, the predetermined semantic classification loss function, the predetermined ArcFace loss function, the determined weight value for the image classification loss function, the determined weight value for the semantic classification loss function and the determined weight value for the ArcFace loss function.

6. The method of claim 1, wherein the sample picture comprises a plurality of text areas, and each text area contains at least one character, and the method further comprises:
extracting a feature vector of a target text area from the plurality of text areas based on an attention network; and
extracting the image feature of the sample picture and the semantic feature of the sample picture based on the extracted feature vector of the target text area.

7. A method of recognizing an image, comprising:
acquiring a to-be-recognized target picture; and
inputting the to-be-recognized target picture into an image recognition model, so as to obtain a text information for the to-be-recognized target picture;
wherein the image recognition model is trained by operations of:
determining a training sample set comprising a plurality of sample pictures and a text label for each sample picture; wherein at least part of the plurality of sample pictures in the training sample set contains an irregular text, an occluded text or a blurred text;
extracting an image feature of each sample picture and a semantic feature of each sample picture based on a feature extraction network of a basic image recognition model; and
training the basic image recognition model based on the extracted image feature of each sample picture, the extracted semantic feature of each sample picture, the text label for each sample picture, a predetermined image classification loss function, and a predetermined semantic classification loss function.

8. The method of claim 7, wherein the sample picture comprises at least one of a shop sign picture, a billboard picture and a slogan picture.

9. The method of claim 7, wherein the training the basic image recognition model based on the extracted image feature of each sample picture, the extracted semantic feature of each sample picture, the text label for each sample picture, a predetermined image classification loss function, and a predetermined semantic classification loss function comprises:
training the basic image recognition model based on the extracted image feature of each sample picture, the extracted semantic feature of each sample picture, the text label for each sample picture, the predetermined image classification loss function, the predetermined semantic classification loss function, and a predetermined ArcFace loss function for aggregating feature information of the same class of target objects and dispersing feature information of different classes of target objects.

10. The method of claim 9, further comprising:
performing a fusion based on the image feature of the sample picture and the semantic feature of the sample picture, so as to determine a fusion sample feature; and
determining a fusion loss based on the fusion sample feature and the ArcFace loss function.

11. The method of claim 9, further comprising:
determining a weight value for the image classification loss function, a weight value for the semantic classification loss function and a weight value for the ArcFace loss function; and
training the basic image recognition model based on the predetermined image classification loss function, the predetermined semantic classification loss function, the predetermined ArcFace loss function, the determined weight value for the image classification loss function, the determined weight value for the semantic classification loss function and the determined weight value for the ArcFace loss function.

12. The method of claim 7, wherein the sample picture comprises a plurality of text areas, and each text area contains at least one character, and the method further comprises:
extracting a feature vector of a target text area from the plurality of text areas based on an attention network; and
extracting the image feature of the sample picture and the semantic feature of the sample picture based on the extracted feature vector of the target text area.

13. An electronic device, comprising:
at least one processor; and
a memory communicatively connected to the at least one processor, wherein the memory stores instructions executable by the at least one processor, and the instructions, when executed by the at least one processor, cause the at least one processor to implement the method of claim 1.

14. An electronic device, comprising:
at least one processor; and
a memory communicatively connected to the at least one processor, wherein the memory stores instructions executable by the at least one processor, and the instructions, when executed by the at least one processor, cause the at least one processor to implement A method of recognizing an image, comprising:
acquiring a to-be-recognized target picture; and
inputting the to-be-recognized target picture into an image recognition model, so as to obtain a text information for the to-be-recognized target picture;
wherein the image recognition model is trained by operations of:
determining a training sample set comprising a plurality of sample pictures and a text label for each sample picture; wherein at least part of the plurality of sample pictures in the training sample set contains an irregular text, an occluded text or a blurred text;
extracting an image feature of each sample picture and a semantic feature of each sample picture based on a feature extraction network of a basic image recognition model; and
training the basic image recognition model based on the extracted image feature of each sample picture, the extracted semantic feature of each sample picture, the text label for each sample picture, a predetermined image classification loss function, and a predetermined semantic classification loss function.

15. The electronic device of claim 14, wherein the sample picture comprises at least one of a shop sign picture, a billboard picture and a slogan picture.

16. The electronic device of claim 14, wherein the processor is further configured to perform operations of:
training the basic image recognition model based on the extracted image feature of each sample picture, the extracted semantic feature of each sample picture, the text label for each sample picture, the predetermined image classification loss function, the predetermined semantic classification loss function, and a predetermined ArcFace loss function for aggregating feature information of the same class of target objects and dispersing feature information of different classes of target objects.

17. The electronic device of claim 14, wherein the processor is further configured to perform operations of:
performing a fusion based on the image feature of the sample picture and the semantic feature of the sample picture, so as to determine a fusion sample feature; and
determining a fusion loss based on the fusion sample feature and the ArcFace loss function.

18. The electronic device of claim 14, wherein the processor is further configured to perform operations of:
determining a weight value for the image classification loss function, a weight value for the semantic classification loss function and a weight value for the ArcFace loss function; and
training the basic image recognition model based on the predetermined image classification loss function, the predetermined semantic classification loss function, the predetermined ArcFace loss function, the determined weight value for the image classification loss function, the determined weight value for the semantic classification loss function and the determined weight value for the ArcFace loss function.

19. A non-transitory computer-readable storage medium having computer instructions stored thereon, wherein the computer instructions allow a computer to implement the method of claim 1.

20. A computer program product containing a computer program, wherein the computer program, when executed by a processor, is allowed to implement the method of claim 7.
